(19) United States
(12) Patent Application Publication
(10) Pub. No.: US 2024/0420328 A1
(43) Pub. Date: Dec. 19, 2024

(54) SYSTEMS AND METHODS FOR CLASSIFICATION OF HISTOPATHOLOGY IMAGES

(71) Applicant: LEICA BIOSYSTEMS IMAGING, INC., Vista, CA (US)

(72) Inventor: Payam Khorramshahi, Vista, CA (US)

(21) Appl. No.: 18/818,011

(22) Filed: Aug. 28, 2024

Related U.S. Application Data
(63) Continuation of application No. PCT/US23/13915, filed on Feb. 27, 2023.
(60) Provisional application No. 63/268,688, filed on Feb. 28, 2022.

(51) Int. Cl. G06T 7/00

(52) U.S. Cl. CPC G06T 7/0012; G06T 2207/20016; G06T 2207/20021; G06T 2207/20081; G06T 2207/20084; G06T 2207/30024

(57) ABSTRACT

Systems and methods for classification of histopathology images are disclosed. In one aspect, an apparatus for detecting a medical condition in a histopathology image includes a hardware memory configured to store executable instructions and a hardware processor in communication with the hardware memory, wherein the executable instructions, when executed by the processor, cause the processor to obtain a plurality of patches at a plurality of magnification levels from the histopathology image, apply a deep learning algorithm to each of the patches, extract, from applying the deep learning algorithm, information representative of a hierarchical relationship that links characteristics of the histopathology image present at one level and another level of the plurality of magnification levels, and identify the medical condition based on the extracted information representative of the hierarchical relationship for characteristics present at the one level and at the another level of the plurality of magnification levels.

### CROSS REFERENCE TO RELATED APPLICATIONS

This application claims priority to, and is a continuation of, international application PCT/US2023/013915, entitled “Systems and Methods for Classification of Histopathology Images,” filed Feb. 27, 2023, which itself claims priority from U.S. Provisional Patent Application 63/268,688, entitled “Systems and Methods for Classification of Histopathology Images”, filed Feb. 28, 2022, each of which is hereby incorporated by reference in its entirety.

### BACKGROUND

The described technology relates to classification of digital pathology images, and in particular, to a hierarchical artificial intelligence approach to classification of histopathology images.

A machine learning diagnostics system can be used to diagnose diseases or other conditions based on a histopathology image. Typically, such systems employ artificial intelligence to identify patterns in this histopathology image which can be used to generate a diagnosis. Improvements to the deep learning architecture used in machine learning diagnostics systems are desirable in order to increase the accuracy of the diagnoses.

### SUMMARY OF THE INVENTION

In one aspect, there is provided an apparatus for detecting a medical condition in a histopathology image, comprising: a hardware memory configured to store executable instructions; and a hardware processor in communication with the hardware memory, wherein the executable instructions, when executed by the processor, cause the processor to: obtain a plurality of patches at a plurality of magnification levels from the histopathology image, apply a deep learning algorithm to each of the patches, extract, from applying the deep learning algorithm, information representative of a hierarchical relationship that links characteristics of the histopathology image present at one level and another level of the plurality of magnification levels, and identify the medical condition based on the extracted information representative of the hierarchical relationship for characteristics present at the one level and at the another level of the plurality of magnification levels.

In some embodiments, the executable instructions, when executed by the processor, further cause the processor to: obtain the histopathology image, and crop the histopathology image to generate the plurality of patches, wherein each of the patches has a different magnification level from the other patches.

In some embodiments, the deep learning algorithm comprises a plurality of convolutional neural networks (CNNs) and a long-short term memory (LSTM) network, and wherein the executable instructions, when executed by the processor, further cause the processor to: provide each of the patches to a corresponding one of the CNNs, and provide an output of each of the CNNs to the LSTM network, wherein the LSTM network is configured to extract the information representative of the hierarchical relationship that links the characteristics of the histopathology image present at the one level and at the another level of the plurality of magnification levels.

In some embodiments, the executable instructions, when executed by the processor, further cause the processor to: sequentially learn, by providing, to the LSTM network, a result of the LSTM network processing an output of a preceding CNN each time the LSTM network is processing an output of a CNN other than an initial CNN, the hierarchical relationship that links the characteristics of the histopathology image present at the one level and at the another level of the plurality of magnification levels.

In some embodiments, the initial CNN has a lowest magnification of any CNN from the plurality of CNNs.

In some embodiments, the deep learning algorithm further comprises a Softmax activation function, and wherein the executable instructions, when executed by the processor, further cause the processor to: provide an output of the LSTM network to the Softmax activation function, and generate a patch level classification based on an output of the Softmax activation function.

In some embodiments, the Softmax activation function is configured to generate the output comprising a probability distribution over a set of predicted output classes. In some embodiments, the hierarchical relationship that links characteristics of the histopathology image present at the plurality of magnification levels represents a relation between tissue morphology at a first one of the magnification levels and cell structure at a second one of the magnification levels.

In some embodiments, the executable instructions, when executed by the processor, further cause the processor to: use an attention mechanism to identify a region of interest within the histopathology image, and crop the histopathology image to generate the plurality of patches based on the region of interest.

In another aspect, there is provided a non-transitory computer readable medium for detecting a medical condition in a histopathology image, the computer readable medium having program instructions for causing a hardware processor to: obtain a plurality of patches at a plurality of magnification levels from the histopathology image; apply a deep learning algorithm to each of the patches; extract, from applying the deep learning algorithm, information representative of a hierarchical relationship that links characteristics of the histopathology image present at one level and another level the plurality of magnification levels; and identify the medical condition based on the extracted information representative of the hierarchical relationship for characteristics present at the one level and the another level of the plurality of magnification levels.

In some embodiments, the instructions are further configured to cause the hardware processor to: obtain the histopathology image; and crop the histopathology image to generate the plurality of patches; wherein each of the patches has a different magnification level from the other patches.

In some embodiments, the deep learning algorithm comprises a plurality of convolutional neural networks (CNNs) and a long-short term memory (LSTM) network, and wherein the instructions are further configured to cause the hardware processor to: provide each of the patches to a corresponding one of the CNNs; and provide an output of each of the CNNs to the LSTM network, wherein the LSTM network is configured to extract the information representative of the hierarchical relationship that links the characteristics of the histopathology image present at the one level and at the another level of the plurality of magnification levels.

In some embodiments, the instructions are further configured to cause the hardware processor to: sequentially learn, by providing, to the LSTM network, a result of the LSTM network processing an output of a preceding CNN each time the LSTM network is processing an output of a CNN other than an initial CNN, the hierarchical relationship that links the characteristics of the histopathology image present at the one level and at the another level of the plurality of magnification levels.

In some embodiments, the initial CNN has a lowest magnification of nay CNN from the plurality of CNNs.

In some embodiments, the deep learning algorithm further comprises a Softmax activation function, and wherein the instructions are further configured to cause the hardware processor to: provide an output of the LSTM network to the Softmax activation function; and generate a patch level classification based on an output of the Softmax activation function.

In some embodiments, the Softmax activation function is configured to generate the output comprising a probability distribution over a set of predicted output classes.

In some embodiments, the hierarchical relationship that links characteristics of the histopathology image present at the plurality of magnification levels represents a relation between tissue morphology at a first one of the magnification levels and cell structure at a second one of the magnification levels.

In some embodiments, the instructions are further configured to cause the hardware processor to: use an attention mechanism to identify a region of interest within the histopathology image; and crop the histopathology image to generate the plurality of patches based on the region of interest.

In yet another aspect, there is provided a method, comprising: obtaining a plurality of patches at a plurality of magnification levels from a histopathology image; applying a deep learning algorithm to each of the patches; extracting, from applying the deep learning algorithm, information representative of a hierarchical relationship that links characteristics of the histopathology image present at one level and another level of the plurality of magnification levels; and identifying a medical condition based on the extracted information representative of the hierarchical relationship for characteristics present at the one level and the another level of the plurality of magnification levels.

In some embodiments, the method further comprises: obtaining the histopathology image; and cropping the histopathology image to generate the plurality of patches, wherein each of the patches has a different magnification level from the other patches.

In some embodiments, the deep learning algorithm comprises a plurality of convolutional neural networks (CNNs) and a long-short term memory (LSTM) network, and wherein the method further comprises: providing each of the patches to a corresponding one of the CNNs; and providing an output of each of the CNNs to the LSTM network, wherein the LSTM network is configured to extract the information representative of the hierarchical relationship that links the characteristics of the histopathology image present at the one level and at the another level of the plurality of magnification levels.

In some embodiments, the method further comprises: sequentially learning, by providing, to the LSTM network, a result of the LSTM network processing an output of a preceding CNN each time the LSTM network is processing an output of a CNN other than an initial CNN, the hierarchical relationship that links the characteristics of the histopathology image present at the one level and at the another level of the plurality of magnification levels.

In some embodiments, the initial CNN has a lowest magnification of any CNN from the plurality of CNNs.

### BRIEF DESCRIPTION OF THE DRAWINGS

The features and advantages of the devices, systems, and methods described herein will become more fully apparent from the following description and appended claims, taken in conjunction with the accompanying drawings. These drawings depict several embodiments in accordance with the disclosure and are not to be considered limiting of its scope. In the drawings, similar reference numbers or symbols typically identify similar components, unless context dictates otherwise. The drawings may not be drawn to scale.

FIG. 1 illustrates an exemplary environment of a multispectral imaging system.

FIG. 2 is an exemplary computing system that may implement any one or more of the imaging devices, image analysis system, user computing device(s), interface server, machine learning server, and other components described herein.

FIG. 3 illustrates an exemplary training and/or inference platform of a machine learning system.

FIGS. 4A-4C illustrate exemplary histopathology images cropped at different levels of magnification from a histopathology whole slide image (WSI).

FIG. 5 is an exemplary block diagram illustrating a deep learning architecture configured to classify histopathology images which can be implemented by the machine learning diagnostics system.

FIG. 6 is another exemplary block diagram illustrating a deep learning architecture configured to classify histopathology images.

FIG. 7 is an exemplary block diagram illustrating a convolutional neural network (CNN) that can be used in the deep learning architecture of FIG. 6.

FIG. 8 is an exemplary block diagram illustrating an LSTM that can be used in the deep learning architecture of FIG. 6.

FIG. 9 is an exemplary flowchart for classifying histopathology images.

### DETAILED DESCRIPTION

The features of the systems and methods for classification of histopathology images will now be described in detail with reference to certain embodiments illustrated in the figures. The illustrated embodiments described herein are provided by way of illustration and are not meant to be limiting. Other embodiments can be utilized, and other changes can be made, without departing from the spirit or scope of the subject matter presented. It will be readily understood that the aspects and features of the present disclosure described below and illustrated in the figures can be arranged, substituted, combined, and designed in a wide variety of different configurations by a person of ordinary skill in the art, all of which are made part of this disclosure.

### Multispectral Imaging System Overview

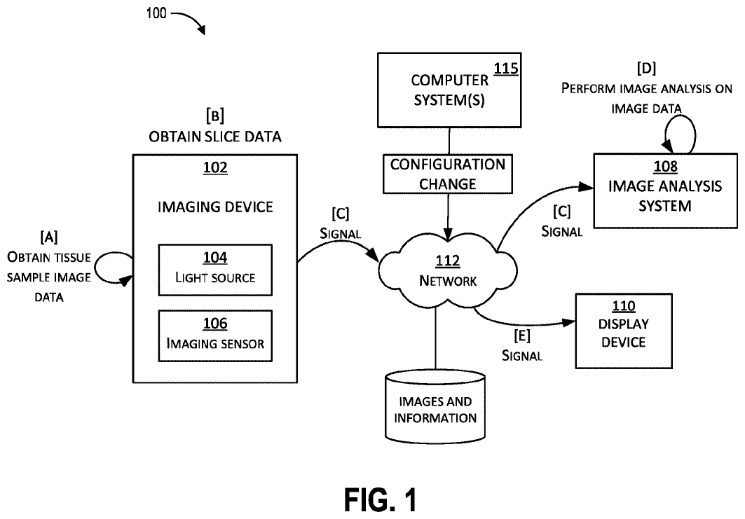

FIG. 1 illustrates an exemplary environment 100 (e.g., a multispectral imaging system) in which a user and/or the multispectral imaging system may analyze a sample. The environment 100 includes an automated slide stainer that is controlled to produce consistently stained slides based on one or more protocols. The environment 100 may also include an imaging device 102 that generates a digital representation (e.g., an image) of a stained slide. The digital representation may be communicated as signal [C] to a network 112 and then to an image analysis system 108 for processing (e.g., feature detection, feature measurements, etc.). The image analysis system 108 may perform image analysis on received image data. The image analysis system 108 may normalize the image data obtained using multispectral imaging for input to a machine learning algorithm and/or model, which may determine characteristics of the image. Results from the image analysis system 108 may be communicated as a signal [E] to one or more display devices 110 (which also may be referred to herein as a “display device” or a “client device”).

In some implementations, the imaging device 102 includes a light source 104 configured to emit multispectral light onto the tissue sample(s) and the imaging sensor 106 configured to detect multispectral light emitted from the tissue sample. The multispectral imaging using the light source 104 may involve providing light to the tissue sample carried by a carrier within a range of frequencies. That is, the light source 104 may be configured to generate light across a spectrum of frequencies to provide multispectral imaging.

In certain embodiments, the tissue sample may reflect light received from the light source 104, which may then be detected at the imaging sensor 106. In these implementations, the light source 104 and the imaging sensor 106 may be located on substantially the same side of the tissue sample. In other implementations, the light source 104 and the imaging sensor 106 may be located on opposing sides of the tissue sample. The imaging sensor 106 may be further configured to generate image data based on the multispectral light detected at the imaging sensor 106. In certain implementations, the imaging sensor 106 may include a high-resolution sensor configured to generate a high-resolution image of the tissue sample. The high-resolution image may be generated based on excitation of the tissue sample in response to laser light emitted onto the sample at different frequencies (e.g., a frequency spectrum).

The imaging device 102 may capture and/or generate image data for analysis. The imaging device 102 may include one or more of a lens, an image sensor, a processor, or memory. The imaging device 102 may receive a user interaction. The user interaction may be a request to capture image data. Based on the user interaction, the imaging device 102 may capture image data. The imaging device may store the image data and other information in the images and information database 113. In some embodiments, the imaging device 102 may capture image data periodically (e.g., every 10, 20, or 30 minutes). In other embodiments, the imaging device 102 may determine that an item has been placed in view of the imaging device 102 (e.g., a histological sample has been placed on a table and/or platform associated with the imaging device 102) and, based on this determination, capture image data corresponding to the item. The imaging device 102 may further receive image data from additional imaging devices. For example, the imaging device 102 may be a node that routes image data from other imaging devices to the image analysis system 108. In some embodiments, the imaging device 102 may be located within the image analysis system 108. For example, the imaging device 102 may be a component of the image analysis system 108. Further, the image analysis system 108 may perform an imaging function. In other embodiments, the imaging device 102 and the image analysis system 108 may be connected (e.g., wirelessly or wired connection). For example, the imaging device 102 and the image analysis system 108 may communicate over a network 112. Further, the imaging device 102 and the image analysis system 108 may communicate over a wired connection. In one embodiment, the image analysis system 108 may include a docking station that enables the imaging device 102 to dock with the image analysis system 108. An electrical contact of the image analysis system 108 may connect with an electrical contact of the imaging device 102. The image analysis system 108 may be configured to determine when the imaging device 102 has been connected with the image analysis system 108 based at least in part on the electrical contacts of the image analysis system 108. In some embodiments, the image analysis system 108 may use one or more other sensors (e.g., a proximity sensor) to determine that an imaging device 102 has been connected to the image analysis system 108. In some embodiments, the image analysis system 108 may be connected to (via a wired or a wireless connection) a plurality of imaging devices.

The image analysis system 108 may include various components for providing the features described herein. In some embodiments, the image analysis system 108 may perform image analysis on the image data received from the imaging device 102. The image analysis system 108 may perform one or more imaging algorithms using the image data.

The image analysis system 108 may be connected to one or more display device 110. The image analysis system 108 may be connected (via a wireless or wired connection) to the display device 110 to provide a recommendation for a set of image data. The image analysis system 108 may transmit the recommendation to the display device 110 via the network 112. In some embodiments, the image analysis system 108 and the user computing device 110 may be configured for connection such that the user computing device 110 may engage and disengage with image analysis system 108 in order to receive the recommendation. For example, the display device 110 may engage with the image analysis system 108 upon determining that the image analysis system 108 has generated a recommendation for the display device 110. Further, the display devices 110 may connect to the image analysis system 108 based on the image analysis system 108 performing image analysis on image data that corresponds to the particular user computing device 110. For example, a user may be associated with a plurality of histological samples. Upon determining, that a particular histological sample is associated with a particular user and a corresponding display device 110, the image analysis system 108 may transmit a recommendation for the histological sample to the particular display device 110. In some embodiments, the display device 110 may dock with the image analysis system 108 in order to receive the recommendation.

In some implementations, the imaging device 102, the image analysis system 108, and/or the display device 110 may be in wireless communication. For example, the imaging device 102, the image analysis system 108, and/or the display device 110 may communicate over a network 112. The network 112 may include any viable communication technology, such as wired and/or wireless modalities and/or technologies. The network may include any combination of Personal Area Networks (“PANs”), Local Area Networks (“LANs”), Campus Area Networks (“CANs”), Metropolitan Area Networks (“MANs”), extranets, intranets, the Internet, short-range wireless communication networks (e.g., ZigBee, Bluetooth, etc.), Wide Area Networks (“WANs”)—both centralized and/or distributed—and/or any combination, permutation, and/or aggregation thereof. The network 112 may include, and/or may or may not have access to and/or from, the internet. The imaging device 102 and the image analysis system 108 may communicate image data. For example, the imaging device 102 may communicate image data associated with a histological sample to the image analysis system 108 via the network 112 for analysis. The image analysis system 108 and the display device 110 may communicate a recommendation corresponding to the image data. For example, the image analysis system 108 may communicate a diagnosis regarding whether the image data is indicative of a disease present in the tissue sample. In some embodiments, the imaging device 102 and the image analysis system 108 may communicate via a first network and the image analysis system 108 and the display device 110 may communicate via a second network. In other embodiments, the imaging device 102, the image analysis system 108, and the display device 110 may communicate over the same network.

One or more third-party computer systems 115 (“computer system 115”) may communicate with the imaging device 102, the image analysis system 108, and/or the display device 110. In some embodiments, the computer system 115 may communicate directly with the imaging device 102, the image analysis system 108, and/or the display device 110 directly or via the network 112.

The computer system 115 may provide information to change functionality on the imaging device 102, the image analysis system 108, and/or the display device 110, or even the network 112. For example, the information may be new software, a software update, new or revised lookup tables, or data or any other type of information that is used in any way to generate, manipulate, transfer or render an image (all being referred to herein as an “update” for ease of reference). The update may be related to, for example, image compression, image transfer, image storage, image display, image rendering, etc. The computer system 115 may provide a message to the device or system to be updated, or may provide a message to a user who interacts with the system control updating the system. In some embodiments, the computer system 115 provides an update automatically, e.g., periodically or as needed/available. In some embodiments, the computer system 115 may provide an update in response to receiving an indication from a user provide the update (e.g., affirmation for the update or a request for the update). Once an update has been made the system may perform quality check to determine if the update change the way images are displayed (e.g., color of tissue samples). If the update has changed the way images are displayed such that the change is greater than the quality threshold, the system may generate a message to alert the user to update as degraded or changed the image display quality.

With reference to an illustrative embodiment, at [A], the imaging device 102 may obtain block data. In order to obtain the block data, the imaging device 102 may image (e.g., scan, capture, record, etc.) a tissue block. The tissue block may be a histological sample. For example, the tissue block may be a block of biological tissue that has been removed and prepared for analysis. As will be discussed in further below, in order to prepare the tissue block for analysis, various histological techniques may be performed on the tissue block. The imaging device 102 may capture an image of the tissue block and store corresponding block data in the imaging device 102. The imaging device 102 may obtain the block data based on a user interaction. For example, a user may provide an input through a user interface (e.g., a graphical user interface (“GUI”)) and request that the imaging device 102 image the tissue block. Further, the user may interact with imaging device 102 to cause the imaging device 102 to image the tissue block. For example, the user may toggle a switch of the imaging device 102, push a button of the imaging device 102, provide a voice command to the imaging device 102, or otherwise interact with the imaging device 102 to cause the imaging device 102 to image the tissue block. In some embodiments, the imaging device 102 may image the tissue block based on detecting, by the imaging device 102, that a tissue block has been placed in a viewport of the imaging device 102. For example, the imaging device 102 may determine that a tissue block has been placed on a viewport of the imaging device 102 and, based on this determination, image the tissue block.

At [B], the imaging device 102 may obtain slice data. In some embodiments, the imaging device 102 may obtain the slice data and the block data. In other embodiments, a first imaging device may obtain the slice and a second imaging device may obtain the block data. In order to obtain the slice data, the imaging device 102 may image (e.g., scan, capture, record, etc.) a slice of the tissue block. The slice of the tissue block may be a slice of the histological sample. For example, the tissue block may be sliced (e.g., sectioned) in order to generate one or more slices of the tissue block. In some embodiments, a portion of the tissue block may be sliced to generate a slice of the tissue block such that a first portion of the tissue block corresponds to the tissue block imaged to obtain the block data and a second portion of the tissue block corresponds to the slice of the tissue block imaged to obtain the slice data. As will be discussed in further detail below, various histological techniques may be performed on the tissue block in order to generate the slice of the tissue block. The imaging device 102 may capture an image of the slice and store corresponding slice data in the imaging device 102. The imaging device 102 may obtain the slice data based on a user interaction. For example, a user may provide an input through a user interface and request that the imaging device 102 image the slice. Further, the user may interact with imaging device 102 to cause the imaging device 102 to image the slice. In some embodiments, the imaging device 102 may image the tissue block based on detecting, by the imaging device 102, that the tissue block has been sliced or that a slice has been placed in a viewport of the imaging device 102.

At [C], the imaging device 102 may transmit a signal to the image analysis system 108 representing the captured image data (e.g., the block data and the slice data). The imaging device 102 may send the captured image data as an electronic signal to the image analysis system 108 via the network 112. The signal may include and/or correspond to a pixel representation of the block data and/or the slice data. It will be understood that the signal may include and/or correspond to more, less, or different image data. For example, the signal may correspond to multiple slices of a tissue block and may represent a first slice data and a second slice data. Further, the signal may enable the image analysis system 108 to reconstruct the block data and/or the slice data. In some embodiments, the imaging device 102 may transmit a first signal corresponding to the block data and a second signal corresponding to the slice data. In other embodiments, a first imaging device may transmit a signal corresponding to the block data and a second imaging device may transmit a signal corresponding to the slice data.

At [D], the image analysis system 108 may perform image analysis on the block data and the slice data provided by the imaging device 102. The image analysis system 108 may perform one or more image processing functions. For example, the image analysis system 108 may perform an imaging algorithm. The image analysis system 108 may also use a machine learning model, such as a convolutional neural network, for performing the image processing functions. Based on performing the image processing functions, the image analysis system 108 can determine a likelihood that the block data and the slice data correspond to the same tissue block. For example, image processing functions may perform an edge analysis of the block data and the slice data and based on the edge analysis, determine whether the block data and the slice data correspond to the same tissue block. The image analysis system 108 may obtain a confidence threshold from the display device 110, the imaging device 102, or any other device. In some embodiments, the image analysis system 108 may determine the confidence threshold based on a response by the display device 110 to a particular recommendation. Further, the confidence threshold may be specific to a user, a group of users, a type of tissue block, a location of the tissue block, or any other factor. The image analysis system 108 may compare the determined confidence threshold with the performed image analysis. Based on this comparison, the image analysis system 108 may generate a recommendation indicating a recommended action for the display device 110 based on the likelihood that the block data and the slice data correspond to the same tissue block. In other embodiments, the image analysis system 108 may provide a diagnosis regarding whether the image data is indicative of a disease present in the tissue sample, for example, based on the results of a machine learning algorithm.

At [E], the image analysis system 108 may transmit a signal to the display device 110. The image analysis system 108 may send the signal as an electrical signal to the display device 110 via the network 112. The signal may include and/or correspond to a representation of the diagnosis. Based on receiving the signal, the display device 110 may determine the diagnosis. In some embodiments, the image analysis system 108 may transmit a series of recommendations corresponding to a group of tissues blocks and/or a group of slices. The image analysis system 108 may include, in the recommendation, a recommended action of a user. For example, the recommendation may include a recommendation for the user to review the tissue block and the slice. Further, the recommendation may include a recommendation that the user does not need to review the tissue block and the slice.

### Computing System Implementation Details

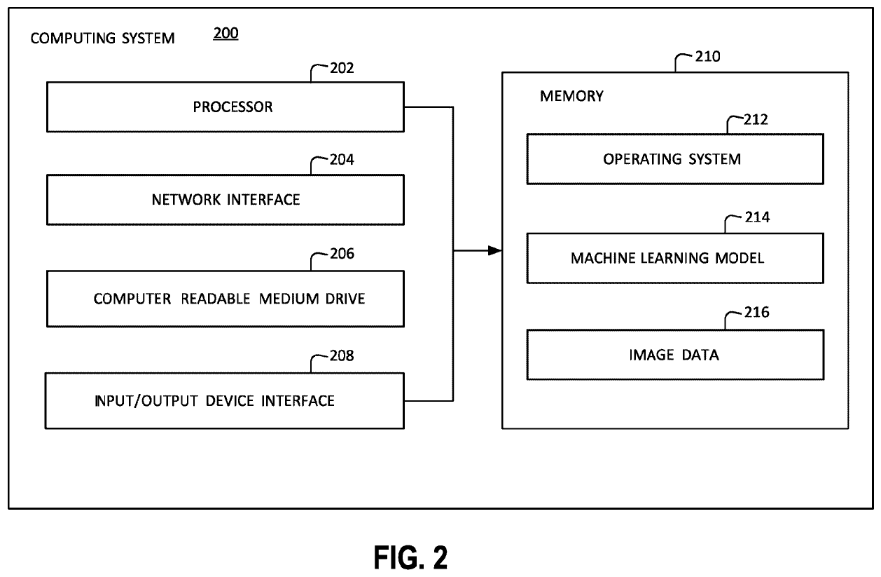

FIG. 2 is an example computing system 200 which, in various embodiments, may implement the functionality of one or more of the devices described herein, such as the imaging device 102, the image analysis system 108, and the display device 110 of the multispectral imaging system illustrated in FIG. 1. In various embodiments, the computing system 200 may implement the functionality of the interface server 304 and/or the machine learning server 316. Referring to FIG. 2, the computing system 200 may include one or more hardware processors 202, such as physical central processing units (“CPUs”), one or more network interfaces 204, such as a network interface cards (“NICs”), and one or more computer readable medium 206. The computer readable medium may be, for example, high-density disks (“HDDs”), solid state drives (“SDDs”), flash drives, and/or other persistent non-transitory computer-readable media. The computing system 200 may also include an input/output device interface 208, such as an input/output (“IO”) interface in communication with one or more microphones, and one or more non-transitory computer readable memory (or “medium”) 210, such as random-access memory (“RAM”) and/or other volatile non-transitory computer-readable media.

The network interface 204 may provide connectivity to one or more networks or computing systems. The hardware processor 202 may receive information and instructions from other computing systems or services via the network interface 204. The network interface 204 may also store data directly to the computer-readable memory 210. The hardware processor 202 may communicate to and from the computer-readable memory 210. The hardware processor 202 may execute instructions and process data in the computer readable memory 210.

The computer readable memory 210 may include computer program instructions that the hardware processor 202 executes in order to implement one or more embodiments described herein. The computer readable memory 210 may store an operating system 212 that provides computer program instructions for use by the computer processor 202 in the general administration and operation of the computing system 200. The computer readable memory 210 may further include program instructions and other information for implementing aspects of the present disclosure. In one example, the computer readable memory 210 includes instructions for training the machine learning model 214. As another example, the computer-readable memory 210 may include image data 216. In another example, the computer-readable memory 210 includes instructions to classify one or more images based on the trained machine learning model 214.

### Machine Learning System Overview

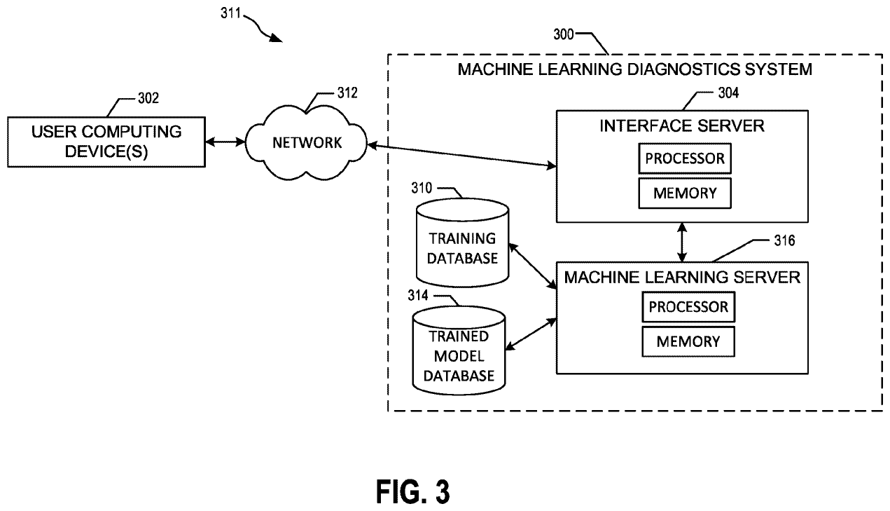

FIG. 3 illustrates an exemplary environment 311 in which the machine learning diagnostics system 300 may train and/or use machine learning models. The environment 311 may include one or more user computing devices 302 (“user computing device 302”) and the network 312. The machine learning diagnostics system 300 may include an interface server 304, a machine learning server 316, a training database 310, and a trained model database 314. Each of the interface server 304 and the machine learning server 316 may include at least a processor and a memory. Each of the interface server 304 and the machine learning server 316 may include additional hardware components, such as the hardware component(s) describe above with respect to FIG. 2.

In various embodiments, the exemplary environment 311 may be used to train one or more machine learning models. For example, the user computing device 302 may transmit (via the network 312) image data, which can include annotated image data, to the interface server 304 for training purposes. The interface server 304 may communicate with the machine learning server 316, such as by transmitting the image data. The machine learning server 316 may store the image data and other training data, such as class label masks, in the training database 310. The machine learning server 316 may train one or more machine learning models using the image data, which can include the annotated image data. Exemplary annotated image data may include annotated images in which a pathologist has drawn contours or circles around tumor regions and marked (e.g., with different colors) the tumor regions as depicting different classes of tumor (e.g., benign, carcinoma, ductal carcinoma in situ (DCIS), uncertain, and lobular carcinoma in situ (LCIS)). The trained machine learning models may be configured to classify input image data. In other words, the trained machine learning models may be configured to output a predicted classification for new input data, such as by predicting whether a patch in the image corresponds to a class, such as, whether abnormal cells are present or not, and if there are abnormal cells, a type of cancer cells. The machine learning server 316 may store the machine learning model(s) in the trained model database 314.

In various embodiments, the exemplary environment 311 may be used to apply one or more trained machine learning models. For example, the user computing device 302 may transmit, via the network 312, image data to the interface server 304 for classification purposes. The interface server 304 may communicate with the machine learning server 316, such as by transmitting the image data to be classified. The machine learning server 316 may retrieve a trained machine learning model from the trained model database 314. The machine learning server 316 apply one or more machine learning models to the input image data to receive a predicted classification. The interface server 304 can receive the predicted classification and may transmit, via the network 312, the predicted classification to the user computing device 302. In various embodiments, the interface server 304 can present a user interface, which includes the predicted classification, to the user computing device 302.

### Techniques for Classification of Histopathology Images

The classification of histopathology images (e.g., typically histopathology WSIs) can be used in diagnosing a disease or condition. In particular, such classification can be particularly useful in diagnosing cancer within a histopathology WSI.

Object categories in some settings are related to each other by means of a taxonomy. In digital pathology, histopathology images can be produced at multiple magnification levels, e.g., by cropping a histopathology WSI. The use of multiple magnifications can aid in the diagnosis of a disease or condition. For example, at a lower magnification level, it is possible to observe properties such as tissue morphologies whereas at a comparatively higher magnification level, it is possible to observe more detailed properties such as cellular structures and other microscopic components. The cellular structures and other microscopic components visible at higher magnification levels may be particularly helpful in cancer diagnostics.

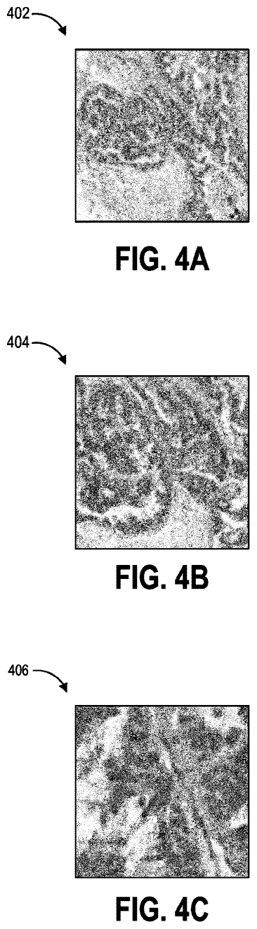

Histopathology images taken at different magnification levels can be represented as a tree based on a hierarchy in which each child node represents more details about its parent node. FIGS. 4A-4C illustrate exemplary histopathology images cropped at different levels of magnification from a histopathology whole slide image (WSI). In particular, FIG. 4A illustrates an exemplary histopathology image 402 at a first level of magnification (e.g., at 10× magnification), FIG. 4B illustrates an exemplary histopathology image 404 at a second level of magnification (e.g., at 20× magnification), and FIG. 4C illustrates an exemplary histopathology image 404 at a second level of magnification (e.g., at 40× magnification). In some embodiments, the machine learning diagnostics system 300 can generate patch images at higher magnification levels by center cropping and resizing one or more histopathology whole slide images (WSIs) at a lowest magnification level. In other embodiments, the machine learning diagnostics system 300 can crop the histopathology images 402-406 from different areas of the histopathology WSI or other source histopathology image. For example, as discussed herein the machine learning diagnostics system 300 can use an attention mechanism to identify one or more region(s) of interest within the histopathology WSI and crop the histopathology WSI to include one or more of the region(s) of interest.

With continued reference to FIGS. 4A-4C, the histopathology image 402 may be represented as a parent node which semantically contains a child node representing the histopathology image 404. Similarly, the histopathology image 404 may be represented as a parent node which semantically contains a child node representing the histopathology image 406. Therefore, a hierarchical relationship exists between images patches 402-406 at different magnification levels. Aspects of this disclosure relate to systems and techniques that can exploit the relationship between cropped histopathology images 402-406 at different magnification levels to improve an artificial intelligence (AI) model's performance in making more accurate diagnostic predictions.

Some AI models make diagnostic predictions using a plurality of convolutional neural networks (CNN) using histopathology images at different magnification levels. Typically, such diagnostic AI models do not use the semantic relation between images taken at different magnification levels, and thus, are not able to use any of the hierarchical relationship information contained in the histopathology images in making the diagnostic predictions.

Thus, aspects of this disclosure relate to AI models that are able to use the hierarchical relationship information contained in histopathology images in making diagnostic predictions. In other words, aspects of this disclosure relate to systems and techniques which can capture and/or extract information representative of the hierarchical relationship that links characteristics of the histopathology image present at the plurality of magnification levels. For example, the linked characteristics may include tissue morphology present at lower magnification and cellular structures at higher magnification. Aspects of this disclosure further relate to using these hierarchical relationship in diagnosing a discase or condition present in the histological images.

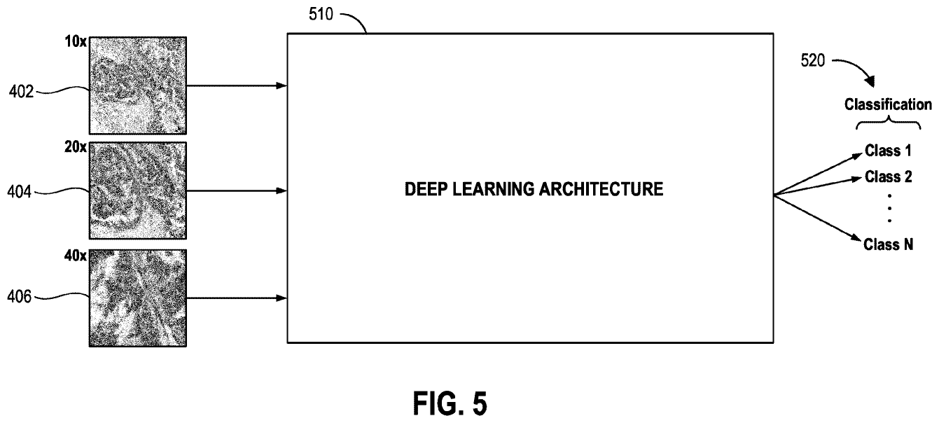

FIG. 5 is an exemplary block diagram illustrating a deep learning architecture 510 configured to classify histopathology images (e.g., histopathology WSIs) which can be implemented by the machine learning diagnostics system 300. In some embodiments, the deep learning architecture 510 of FIG. 5 is an end-to-end deep learning architecture 510 configured to classify histopathology images 402-406 into one of a plurality of classes 520. In one implementation, the deep learning architecture 510 can be configured to classify breast cancer histology images 402-406 into one of five classes 520 (e.g., benign, carcinoma, ductal carcinoma in situ (DCIS), normal, and lobular carcinoma in situ (LCIS)).

The deep learning architecture 510 is configured to receive a plurality of patch images 402-406 which are cropped at different magnification levels from one or more histopathology WSIs. Depending on the implementation, a histopathology WSI may have a size one the order of 100,000×100,000 pixels, which can occupy up to 3 GB of data. Due to the large size of histopathology WSIs, it can be impractical to fit an entire histopathology WSI in memory. Accordingly, aspects of this disclosure use patches 402-406 cropped from a histopathology WSI for training AI or deep learning models.

In the example illustrated in FIG. 5, the deep learning architecture 510 may receive three cropped patch images in which a first patch 402 is center cropped at 10× magnification, a second patch 404 is center cropped at 20× magnification, and a third patch 406 is center cropped at 40× magnification. However, in other embodiments, the deep learning architecture 510 can be configured to receive as few as two cropped patches 402-406 or four or more cropped patches 402-406 at different magnification levels. For example, the machine learning diagnostics system 300 may crop the histopathology WSI and resize the cropped image to generate the first patch 402, with the subsequent patches 404 and 406 being cropped and resized from the previously generated patch 402 and 404. In some embodiments, the learning diagnostics system 300 may resize each of the patches 402-406 to substantially the same size.

Depending on the embodiment, the machine learning diagnostics system 300 can crop different portions of an input or source histopathology image (e.g., a histopathology WSI) to produce the patches 402-406 rather than using a center crop. For example, in some embodiments, the machine learning diagnostics system 300 can implement an attention mechanism to identify a region of interest within an input histopathology image to generate each of the patches 402-406. As used herein, an attention mechanism generally refers to a category of neural networks configured to mimic cognitive attention in order to identify one or more regions of interest within an image. The machine learning diagnostics system 300 can implement one or more different types of attention mechanisms, such as: transformers, vision transformers, recurrent attention model, or other methods of reinforcement learning. In yet other embodiments, the machine learning diagnostics system 300 can crop different portions of an input histopathology image to produce the patches 402-406 using other systematic cropping techniques, such as a random cropping technique, cropping the upper-left corner of the image, or any other cropping technique.

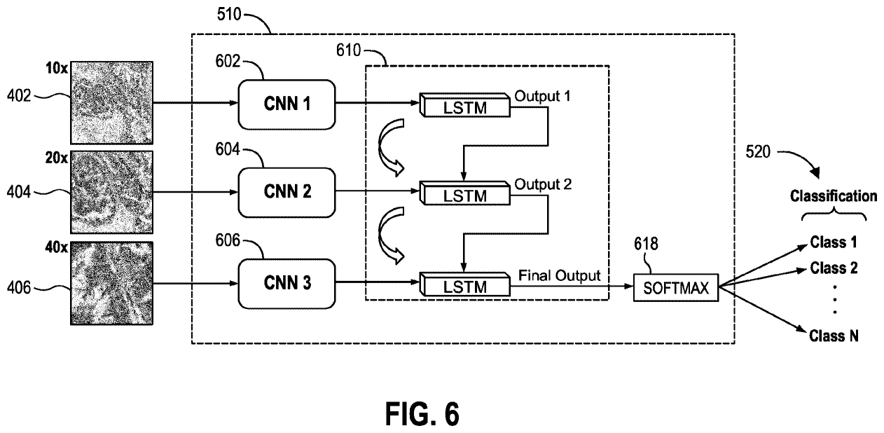

The deep learning architecture 510 is configured to extract at least some information regarding the relationship between cropped histopathology images 402-406 at different magnification levels and use the extracted information in generating the classification 520 of the received patches 402-406. FIG. 6 is another exemplary block diagram illustrating a deep learning architecture 510 configured to classify histopathology images. In particular, FIG. 6 provides an exemplary implementation of the deep learning architecture 510. In the illustrated embodiment, the deep learning architecture 510 includes a plurality of CNNs 602, 604, and 606, a long-short term memory (LSTM) network 610, and a Softmax activation function 618. As used herein, an LSTM network is a type of recurrent neural network (RNN), in particular, a many-to-one RNN cell. It should be noted that, while FIG. 6 illustrates the LSTM network 610 as comprising a plurality of LSTM cells, the LSTM network 610 would preferably not include multiple discrete cells. Instead, the individual cells are illustrated because, as described below, the LSTM network 610 would receive different inputs on each of a series of iterations, and the individual cells are intended to clearly illustrate the different iterations (i.e., each cell represents the same LSTM network on a different iteration) of processing by the LSTM network 610.

Each of the CNNs 602-606 is configured to receive a corresponding one of the image patches 402-406. Thus, the number of CNNs 602-606 included in the deep learning architecture 510 may correspond to the number of input patches 402-406 the deep learning architecture 510 is configured to receive. Each of the CNNs 602-606 is configured (e.g. trained) to learn spatial information within the corresponding received patch images 402-406 at the specific magnification level of the patch images 402-406.

The LSTM network 610 is configured (e.g., trained) to receive the output from the CNNs 602-606. The LSTM network 610 is configured to process the outputs from the CNNs 602-606 in a sequential manner in order to learn the semantic relationship (e.g., the hierarchical representation) within the patches 402-406 at different magnification levels. For example, by processing the outputs from the CNNs 602-606 in a sequential manner, the LSTM network 610 can learn the semantic relationship that links the tissue morphology from a lower magnification level with the cellular structure from a higher magnification.

In order to sequentially process the outputs from the CNNs 602-606, the LSTM network 610 may include a processing loop such that when the LSTM network 610 is processing output from a CNN, it may also receive the output from processing the output of the previous CNN. Excepting when it is processing the output of the first CNN 602, the LSTM network 610 receives both the output from a CNN 604 and 606 and the output from processing the previous CNN.

The LSTM network 610 is configured to provide the output produced by processing the output of the final CNN to the Softmax activation function 618. The Softmax activation function 618 can be configured to classify the histopathology image based on the output from the LSTM network 610, thereby producing the classification 520 of the histopathology image. The classification 510 may include a probability that the histopathology image belongs to each of a plurality of classes (e.g., Class 1, Class 2, . . . . Class N). For example, the Softmax activation function 618 may be configured to normalize the output of the LSTM network 610 to a probability distribution over the predicted output classes.

Advantageously, by using the deep learning architecture 510 the machine learning diagnostics system 300 can not only learn the spatial information from each if the patch images 402-406, but the machine learning diagnostics system 300 can also analyze the patch images 402-406 sequentially using the LSTM network 610 to extract the hierarchical representation at different magnification levels. Accordingly, because the deep learning architecture 510 is able to learn at least some of the semantic relation between images taken at different magnification levels, the machine learning diagnostics system 300 can more accurately classify histopathology images compared to models that do not learn such semantic relationships.

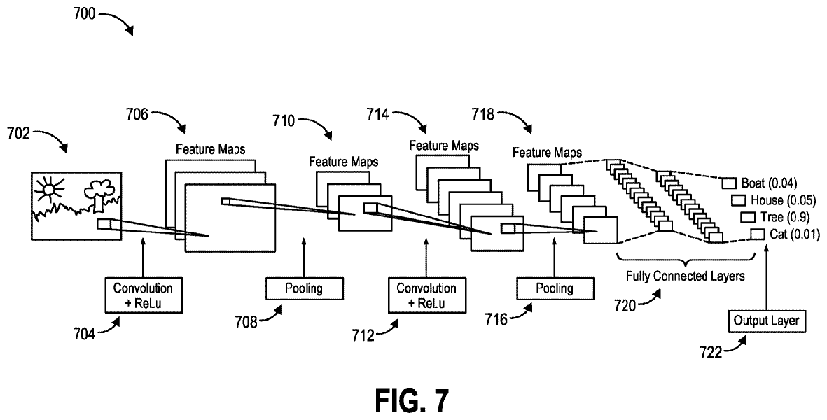

FIG. 7 is an exemplary block diagram illustrating a convolutional neural network (CNN) 700 that can be used in the deep learning architecture. In deep learning, CNN refers to a class of artificial neural network, which is often used to analyze image data. CNNs are also known as shift invariant or space invariant artificial neural networks, based on the shared-weight architecture of the convolution kernels or filters that slide along input features and provide translation equivariant responses known as feature maps. CNNs take advantage of the hierarchical pattern in data and assemble patterns of increasing complexity using smaller and simpler patterns embossed in their filters.

With reference to FIG. 7, the CNN 700 is configured to receive an input 702 which is a tensor with a shape: (number of inputs)×(input height)×(input width)×(input channels). The input 702 passes through a convolutional layer 704 which abstracts the input 702 into a feature map 706, also called an activation map, with shape: (number of inputs)×(feature map height)×(feature map width)×(feature map channels). The CNN 700 also includes a plurality of pooling layers 708 and 716 and convolution layers 704 and 712 configured to convolve the input received at the convolution layer 704 and 712 and pass the result onto the next layer. Each layer 704, 708, 712, 716, and 720 produces a set of feature maps 706, 710, 714, and 718 or a final classification output 722 of the CNN 700.

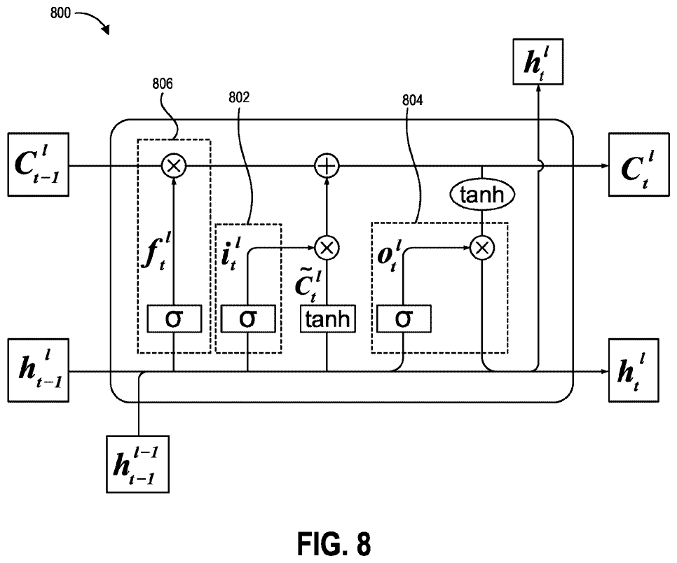

FIG. 8 is an exemplary block diagram illustrating a Long short-term memory (LSTM) network 800 that can be used in the deep learning architecture of FIG. 6. LSTM network 800 is an artificial RNN architecture used in the field of deep learning. Unlike standard feedforward neural networks, LSTM network 800 has feedback connections. An LSTM network 800 can process not only single data points (such as images), but also entire sequences of data. A common LSTM network 800 includes an input gate 802, an output gate 804, and a forget gate 806. The LSTM network 800 is configured to remember values over arbitrary time intervals and the input, output, and forget gates 802-806 are configured to regulate the flow of information into and out of the LSTM network 800.

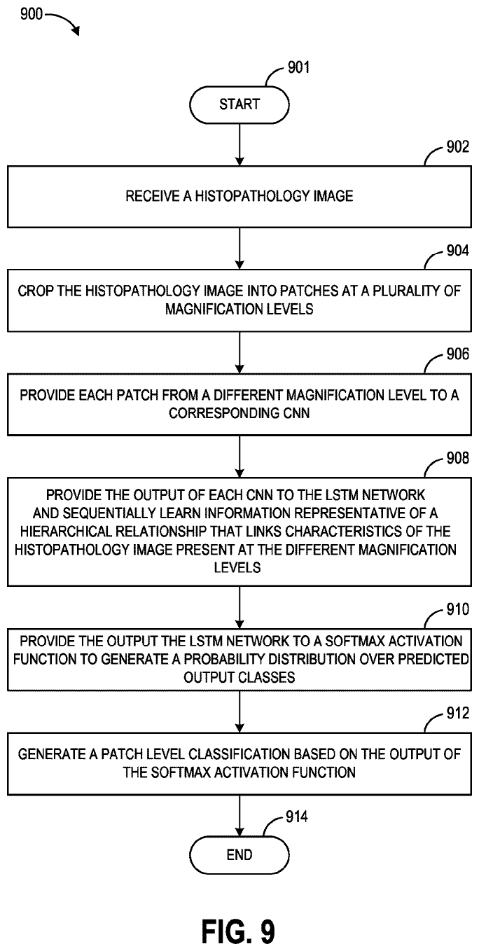

FIG. 9 is an exemplary flowchart for classifying histopathology images. With reference to FIG. 9, one or more blocks of the method 900 may be implemented, for example, by the processor the machine learning diagnostics system 300 of FIG. 3. The method 900 begins at block 901. At block 902, the processor is configured to receive a histopathology image 902. The image may be received from an imaging device such as shown in FIG. 1, or may be received as data via a communications path or retrieved from memory. At block 904, the processor is configured to crop the histopathology image into equal sized patches at a plurality of magnification levels (e.g., patches 402-406 of FIGS. 4-6 which, as noted in the discussion of those figures, may have a variety of magnification levels, such as predefined levels like 10×, 20× and 40×). For example, the processor may center crop the histopathology image to generate two or more patches at different magnification levels. In other embodiments, the processor may apply an attention mechanism to identify a region of interest within the histopathology image and crop the histopathology image centered on the region of interest. Other approaches to cropping a histopathology image, such as random cropping, cropping the upper-left corner, or other cropping techniques may also be used.

At block 906, the processor is configured to provide each patch from a different magnification level to a corresponding CNN (e.g., the CNNs 602-606 of FIG. 6). At block 908, the processor is configured to provide the output of each of the CNNs to a LSTM network (e.g., the LSTM network 610 of FIG. 6) and sequentially learn information representative of a hierarchical relationship that links characteristics of the histopathology image present at the plurality of magnification levels using the LSTM network 610. For example, the characteristics of the histopathology image present at the plurality of magnification levels may represent the relation between tissue morphology and cell structure at different the magnification levels.

At block 910, the processor is configured to provide the output of the LSTM network's processing to a function which generates a probability distribution over predicted output classes (e.g., a Softmax activation function 618 as shown in FIG. 6). For example, when the machine learning diagnostics system 300 is configured to diagnose a medical condition such as breast cancer, the Softmax activation function (or other probability distribution generation function) may generate a probability for each class (e.g., benign, carcinoma, DCIS, normal, and LCIS) to which the histopathology image may belong. That is, when the deep learning architecture 510 is trained with annotated images in which portions have been marked by a pathologist as benign, carcinoma, DCIS, normal, and LCIS, the LSTM network may provide an output with numeric values corresponding to each of those classes, and the Softmax activation function may transform those numeric values into a probability for each class.

At block 912, the processor is configured to generate a patch level classification based on the output of the Softmax activation function (or other probability distribution generation function. For example, the classification can classify the patch images 402-406 as belonging to the class having the highest probability identified by the Softmax activation function. The method 900 ends at block 914.

### Conclusion

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes can be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures can be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (e.g., top, bottom, side, up, down, inward, outward, etc.) are generally used with reference to the orientation shown in the figures and are not intended to be limiting. For example, the top surface described above can refer to a bottom surface or a side surface. Thus, features described on the top surface may be included on a bottom surface, a side surface, or any other surface.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

The above description discloses several methods and materials of the present invention(s). This invention(s) is susceptible to modifications in the methods and materials, as well as alterations in the fabrication methods and equipment. Such modifications will become apparent to those skilled in the art from a consideration of this disclosure or practice of the invention(s) disclosed herein. Consequently, it is not intended that this invention(s) be limited to the specific embodiments disclosed herein, but that it covers all modifications and alternatives coming within the true scope and spirit of the invention(s) as embodied in the attached claims.

What is claimed is:

1. An apparatus for detecting a medical condition in a histopathology image, comprising:
a hardware memory configured to store executable instructions; and
a hardware processor in communication with the hardware memory, wherein the executable instructions, when executed by the processor, cause the processor to:
obtain a plurality of patches at a plurality of magnification levels from the histopathology image, apply a deep learning algorithm to each of the patches,
extract, from applying the deep learning algorithm, information representative of a hierarchical relationship that links characteristics of the histopathology image present at one level and another level of the plurality of magnification levels, and
identify the medical condition based on the extracted information representative of the hierarchical relationship for characteristics present at the one level and at the another level of the plurality of magnification levels.

2. The apparatus of claim 1, wherein the executable instructions, when executed by the processor, further cause the processor to:
obtain the histopathology image, and
crop the histopathology image to generate the plurality of patches,
wherein each of the patches has a different magnification level from the other patches.

3. The apparatus of claim 1, wherein the deep learning algorithm comprises a plurality of convolutional neural networks (CNNs) and a long-short term memory (LSTM) network, and wherein the executable instructions, when executed by the processor, further cause the processor to:
provide each of the patches to a corresponding one of the CNNs, and provide an output of each of the CNNs to the LSTM network,
wherein the LSTM network is configured to extract the information representative of the hierarchical relationship that links the characteristics of the histopathology image present at the one level and at the another level of the plurality of magnification levels.

4. The apparatus of claim 3, wherein the executable instructions, when executed by the processor, further cause the processor to:
sequentially learn, by providing, to the LSTM network, a result of the LSTM network processing an output of a preceding CNN each time the LSTM network is processing an output of a CNN other than an initial CNN, the hierarchical relationship that links the characteristics of the histopathology image present at the one level and at the another level of the plurality of magnification levels.

5. The apparatus of claim 4, wherein the initial CNN has a lowest magnification of any CNN from the plurality of CNNs.

6. The apparatus of claim 3, wherein the deep learning algorithm further comprises a Softmax activation function, and wherein the executable instructions, when executed by the processor, further cause the processor to:
provide an output of the LSTM network to the Softmax activation function, and generate a patch level classification based on an output of the Softmax activation function.

7. The apparatus of claim 6, wherein the Softmax activation function is configured to generate the output comprising a probability distribution over a set of predicted output classes.

8. The apparatus of claim 1, wherein the hierarchical relationship that links characteristics of the histopathology image present at the plurality of magnification levels represents a relation between tissue morphology at a first one of the magnification levels and cell structure at a second one of the magnification levels.

9. The apparatus of claim 1, wherein the executable instructions, when executed by the processor, further cause the processor to:
use an attention mechanism to identify a region of interest within the histopathology image, and crop the histopathology image to generate the plurality of patches based on the region of interest.

10. A non-transitory computer readable medium for detecting a medical condition in a histopathology image, the computer readable medium having program instructions for causing a hardware processor to:
obtain a plurality of patches at a plurality of magnification levels from the histopathology image;
apply a deep learning algorithm to each of the patches;
extract, from applying the deep learning algorithm, information representative of a hierarchical relationship that links characteristics of the histopathology image present at one level and another level the plurality of magnification levels; and
identify the medical condition based on the extracted information representative of the hierarchical relationship for characteristics present at the one level and the another level of the plurality of magnification levels.

11. The non-transitory computer readable medium of claim 10, wherein the instructions are further configured to cause the hardware processor to:
obtain the histopathology image; and
crop the histopathology image to generate the plurality of patches;
wherein each of the patches has a different magnification level from the other patches.

12. The non-transitory computer readable medium of claim 10 wherein the deep learning algorithm comprises a plurality of convolutional neural networks (CNNs) and a long-short term memory (LSTM) network, and wherein the instructions are further configured to cause the hardware processor to:
provide each of the patches to a corresponding one of the CNNs; and
provide an output of each of the CNNs to the LSTM network,
wherein the LSTM network is configured to extract the information representative of the hierarchical relationship that links the characteristics of the histopathology image present at the one level and at the another level of the plurality of magnification levels.

13. The non-transitory computer readable medium of claim 12, wherein the instructions are further configured to cause the hardware processor to:
provide the output of each of the CNNs to a corresponding one of the LSTM cells; and
sequentially learn, by providing, to the LSTM network, a result of the LSTM network processing an output of a preceding CNN each time the LSTM network is processing an output of a CNN other than an initial CNN, the hierarchical relationship that links the characteristics of the histopathology image present at the one level and at the another level of the plurality of magnification levels.

14. The non-transitory computer readable medium of claim 13, wherein the initial CNN has a lowest magnification of any CNN from the plurality of CNNs.

15. The non-transitory computer readable medium of claim 12, wherein the deep learning algorithm further comprises a Softmax activation function, and wherein the instructions are further configured to cause the hardware processor to:
provide an output of the LSTM network to the Softmax activation function; and generate a patch level classification based on an output of the Softmax activation function.

16. The non-transitory computer readable medium of claim 15, wherein the Softmax activation function is configured to generate the output comprising a probability distribution over a set of predicted output classes.

17. The non-transitory computer readable medium of claim 10, wherein the hierarchical relationship that links characteristics of the histopathology image present at the plurality of magnification levels represents a relation between tissue morphology at a first one of the magnification levels and cell structure at a second one of the magnification levels.

18. The non-transitory computer readable medium of claim 16, wherein the instructions are further configured to cause the hardware processor to:
use an attention mechanism to identify a region of interest within the histopathology image; and
crop the histopathology image to generate the plurality of patches based on the region of interest.

19. A method, comprising:
obtaining a plurality of patches at a plurality of magnification levels from a histopathology image;
applying a deep learning algorithm to each of the patches;
extracting, from applying the deep learning algorithm, information representative of a hierarchical relationship that links characteristics of the histopathology image present at one level and another level of the plurality of magnification levels; and
identifying a medical condition based on the extracted information representative of the hierarchical relationship for characteristics present at the one level and the another level of the plurality of magnification levels.

20. The method of claim 19, further comprising:
obtaining the histopathology image; and
cropping the histopathology image to generate the plurality of patches, wherein each of the patches has a different magnification level from the other patches.
